(19) United States
(12) Patent Application Publication
(10) Pub. No.: US 2015/0362127 A1
(43) Pub. Date: Dec. 17, 2015

(54) SINGLE PHASE COLD HELIUM TRANSFER LINE FOR CRYOGENIC HEAT TRANSFER APPLICATIONS

(71) Applicant: UT-Battelle, LLC, Oak Ridge, TN (US)

(72) Inventors: Robert C. Duckworth, Knoxville, TN (US); Larry R. Baylor, Farragut, TN (US); Stephen K. Combs, Knoxville, TN (US); Steven J. Meitner, Oak Ridge, TN (US)

(21) Appl. No.: 14/695,287

(22) Filed: Apr. 24, 2015

Related U.S. Application Data
(60) Provisional application No. 62/011,070, filed on Jun. 12, 2014.

(51) Int. Cl. F17C 7/02

(52) U.S. Cl. CPC F17C 7/02; F17C 2201/0138; F17C 2203/0629; F17C 2203/0609; F17C 2223/0161; F17C 2260/021; F17C 2265/06

(57) ABSTRACT

A cryogenic material transfer line has an inner tubular member and a coaxially disposed outer tubular member that together define an annular volume. Within the annular volume is a flow enhancing feature that increases the residence time and path length of a gas flowing within the annulus. The gas flowing inside the annulus thermally interacts with a fluid outside of the transfer line to provide a more consistent gas temperature and flow rate for use in scientific experiments.

### CROSS-REFERENCE TO RELATED APPLICATIONS

This application claims priority under 35 U.S.C. §119 to U.S. provisional patent application Ser. No. 62/011,070, titled “SINGLE PHASE COLD HELIUM TRANSFER LINE FOR CRYOGENIC HEAT TRANSFER APPLICATIONS”, and filed Jun. 12, 2014, which is hereby incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### BACKGROUND OF THE INVENTION

1. Field of the Invention

The present disclosure relates to cryogenic materials and more particularly to apparatuses and methods for transferring such materials from a storage dewar to another location for use in research experiments and other uses.

2. Description of the Related Art

Heat transfer experiments near liquid helium temperatures, approximately 5 degrees Kelvin, provide representative evaluation of new configurations where thermal properties of materials under test are important. Experiments using liquid helium work from a temperature standpoint, but the two-phase nature of boiling or forced flow results in temperature fluctuations that can impact characterization and complicate modeling. Helium gas forms above liquid helium in storage dewars that can range in size from 30 liters up to 50000 liters.

A conventional helium gas transfer line will function, but availability of full liquid helium dewars can be limited. The use of a conventional helium gas transfer line without flow enhancements results in helium gas flow with higher flow temperatures that impacts experimental test results and test duration. For heat transfer applications at or near liquid helium temperatures, heat loads applied to the devices under test can increase pressure in the liquid helium system and prevent consistent transfer of liquid from the storage dewar, thus affecting the results of the test and wasting liquid helium. Improvements to cryogenic material transfer lines are needed.

### BRIEF SUMMARY OF THE INVENTION

Disclosed are examples of a cryogenic gas transfer line and methods of transferring a cryogenic gas from a storage dewar to a location outside of the storage dewar. For example, the outside location may be a characterization experiment.

A cryogenic gas transfer line includes an inner wall that defines an inner tubular member that is disposed coaxially inside of an outer wall that defines an outer tubular member. An annulus is defined between the coaxial tubular members and the outer tubular member is sealed at a lowest end. An inlet aperture in the outer tubular member is located at a height that is in a gas region of a storage dewar when the transfer line is inserted into a storage dewar. A flow enhancing feature is disposed inside of the annulus. A gas stored at a cryogenic temperature in the gas region of a storage dewar will: enter the annulus through the inlet aperture; flow downward through the flow enhancing feature that is disposed within a liquid region located below the gas region of a storage dewar; reverse direction at the lowest end; and flow upward through the inner tubular member and out of a storage dewar when the transfer line is inserted into a storage dewar. In other examples, a storage dewar is provided with the transfer line as an assembly.

A method for transferring a gas stored at a cryogenic temperature from inside a storage dewar to a location outside of the storage dewar comprises the steps of: a) inserting into a storage dewar a transfer line that has an inner wall that defines an inner tubular member disposed coaxially inside of an outer wall that defines a tubular member. The transfer line having an annulus defined between the coaxial tubular members and the outer tubular member is sealed at a lowest end. An inlet aperture in the outer tubular member is located at a height that is in a gas region of a storage dewar when the transfer line is inserted into a storage dewar, and a flow enhancing feature is disposed inside of the annulus; b) opening a cryogenic valve that controls the flow of a gas within the inner tubular member; and c) transferring a cryogenic gas from the gas region inside of the storage dewar to the location outside of the storage dewar.

### BRIEF DESCRIPTION OF THE SEVERAL VIEWS OF THE DRAWINGS

The exemplary apparatuses and methods may be better understood with reference to the following drawings and detailed description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 illustrates an exemplary cryogenic gas transfer line as assembled with a storage dewar and a device under test;

FIG. 2 illustrates a detailed view of the transfer line of FIG. 1;

FIG. 3 illustrates a schematic view of the flow direction of cryogenic gas at the lower end of the transfer line of FIG. 1;

FIG. 4 illustrates a detailed view of an exemplary flow enhancing feature;

FIG. 5 illustrates non-exhaustive examples of various flow enhancing features;

FIG. 6 is a chart illustrating measured gas temperatures with and without flow enhancing features as liquid helium level changes;

FIG. 7 is a chart illustrating measured gas temperatures with flow enhancing features of different lengths as liquid helium level changes;

FIG. 8 is a chart illustrating measured inlet and outlet gas temperatures in the gas transfer line over time; and

FIG. 9 illustrates tables of average outlet temperature at various mass flow rates for transfer lines with (top) and without (bottom) flow enhancing features.

### DETAILED DESCRIPTION OF THE INVENTION

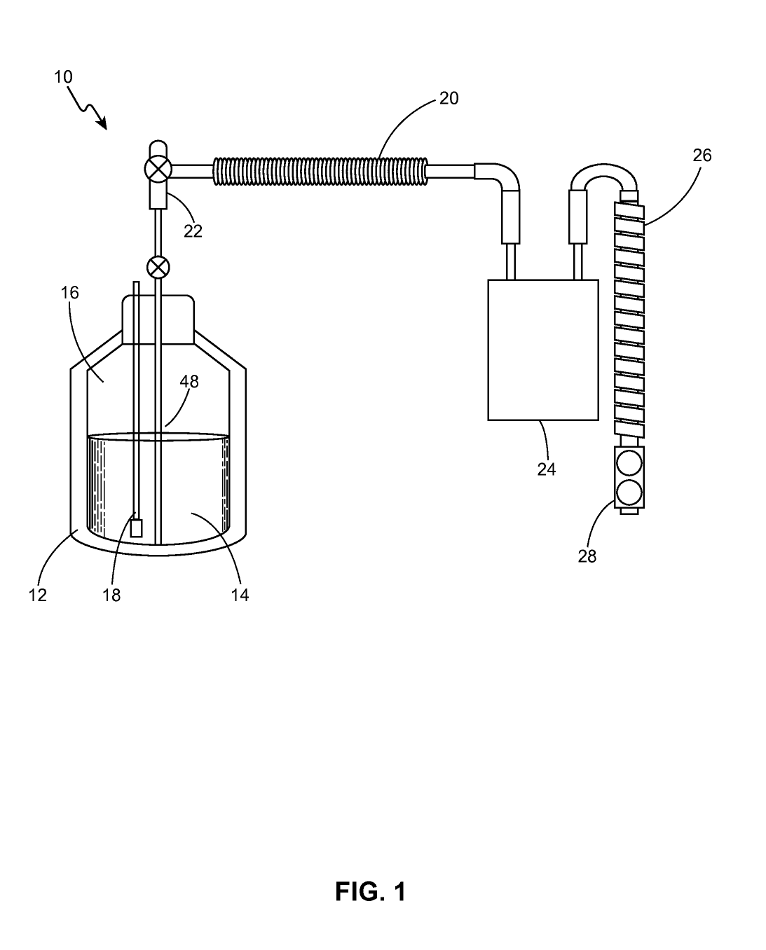

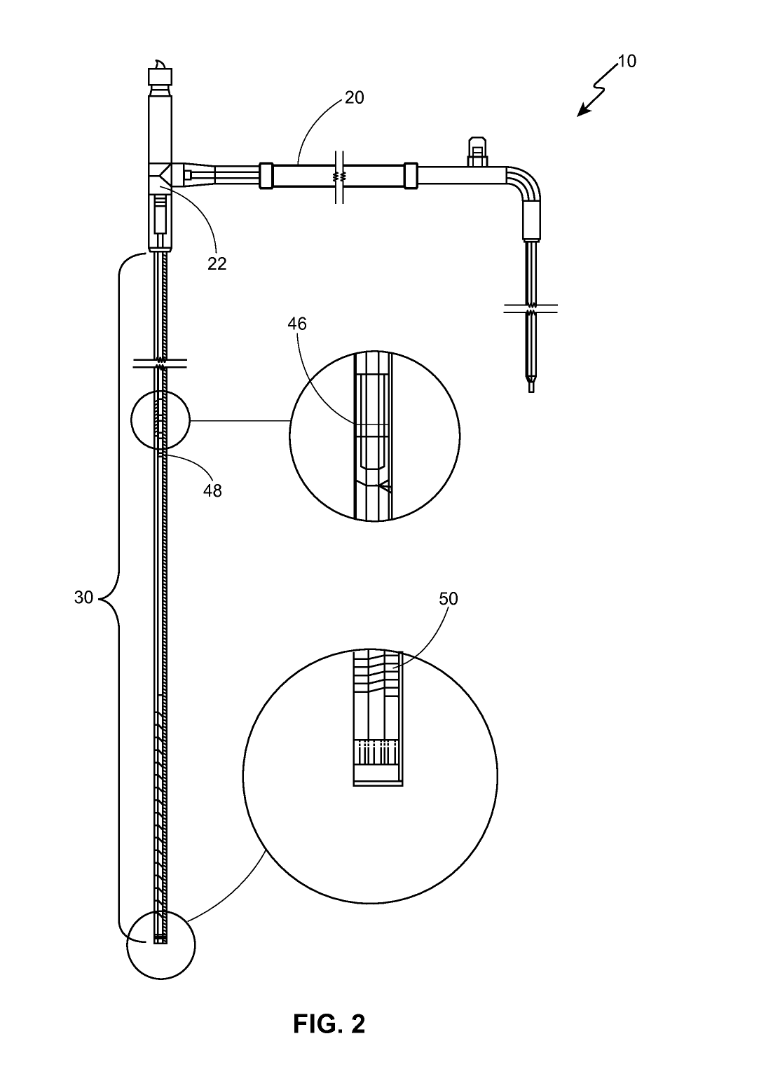

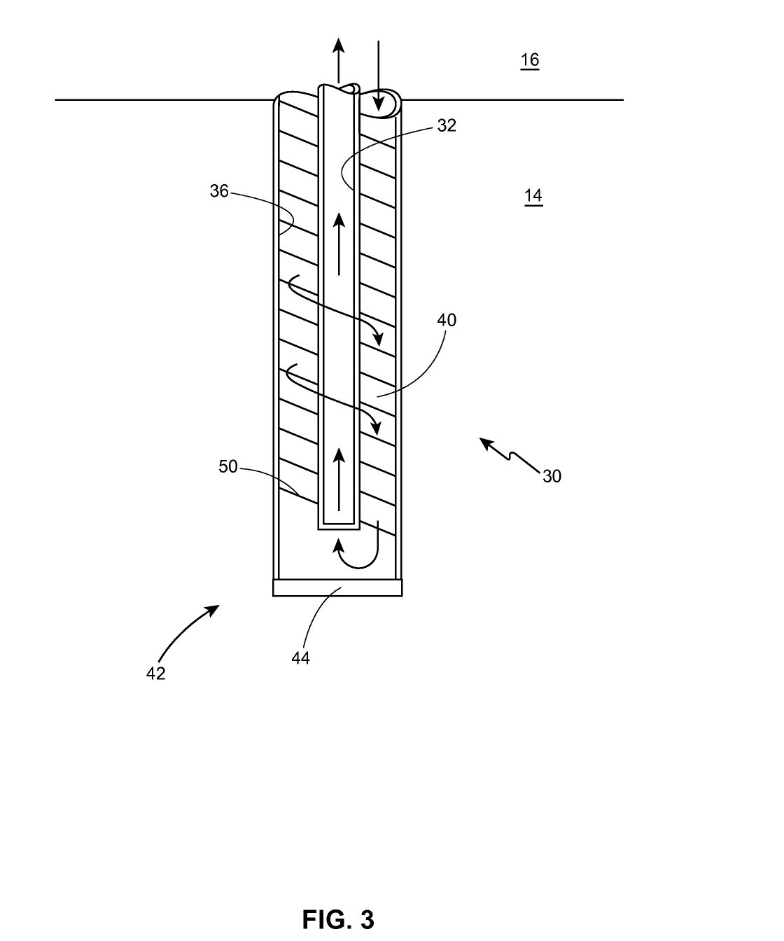

With reference first to FIGS. 1-3, an exemplary single-phase helium gas transfer line 10, which overcomes the issues that two-phase liquid helium flow present in cryogenic heat transfer characterization is provided. The transfer line 10 can be joined to a storage dewar 12 for storing a material such as helium at cryogenic temperatures includes a lower liquid region 14 and an upper gas region 16. The liquid region 14 of a standard 250 liter liquid helium dewar extends approximately 70 centimeters from the bottom of the dewar when full and, as the material is used, the level of the liquid region 14 decreases while the gas region 16 increases. An internal pressurization control heater 18 is used to maintain the proper pressure in the dewar 12. A flexible vacuum jacketed line 20 is disposed between a gas flow control valve 22 and a device 24 under test. A heater 26 and flow meter 28 complete a typical experimental setup.

The transfer line 10 intakes pressurized gas, for example helium gas, from the gas region 16 of the dewar 12 and passes it through a coaxial tube structure 30 that is at least partially immersed in the liquid region 14 within the dewar 12. In this configuration, the gas flows with more consistent temperatures, between approximately 5 K and 10 K, and delivery pressures, between approximately 1.2 bar and 1.6 bar. These consistent flow conditions are desirable for prototype application development related to the production of cryogenic pellets for fusion fueling and plasma shutdown as well as cryopump development for fusion vacuum systems as well as other applications.

The coaxial tubular structure 30 includes an inner wall 32 that defines an inner tubular member 34 and an outer wall 36 that defines an outer tubular member 38. The inner tubular member 34 is disposed coaxially inside of the outer tubular member 38 with an annulus 40 defined between the coaxial members 34, 38. A lower end 42 of the outer tubular member 38 is sealed with a disc 44. One or more spacers 46 space the inner 34 and outer 38 tubular members apart and keep the annulus 40 area consistent. An inlet aperture 48 is defined by the outer wall 36 and is positioned at a height that is above the liquid region 14 when the transfer line 10 is inserted into a storage dewar 12. For example, a 0.25 inch aperture 48 may be positioned at a height of 75 cm from the lower end 42 of the outer tubular member 38 to ensure that it is in the gas region of a full, 250 liter dewar of liquid helium. For smaller or larger sized dewars, the aperture 48 is suitably positioned in the gas regions 16.

In order to improve the heat exchange between the gas and the liquid while minimizing the gas temperature with continuously lowering liquid region 14 level, a flow enhancing feature 50 is disposed in the annulus 40 area. The flow enhancing feature 50 forces the gas to flow circuitously around the inner tubular member 34 and within the outer tubular member 38, increasing the path length and residence time of the gas while it's flowing within the liquid region 14. The extent of the flow enhancing features 50, which are designed to increase the surface area within the transfer line and/or change the flow direction to increase the thermal transfer length and residence time, determine the outlet temperature of the transfer line 10 and can be adjusted for different flow rates, outlet temperatures, and test durations.

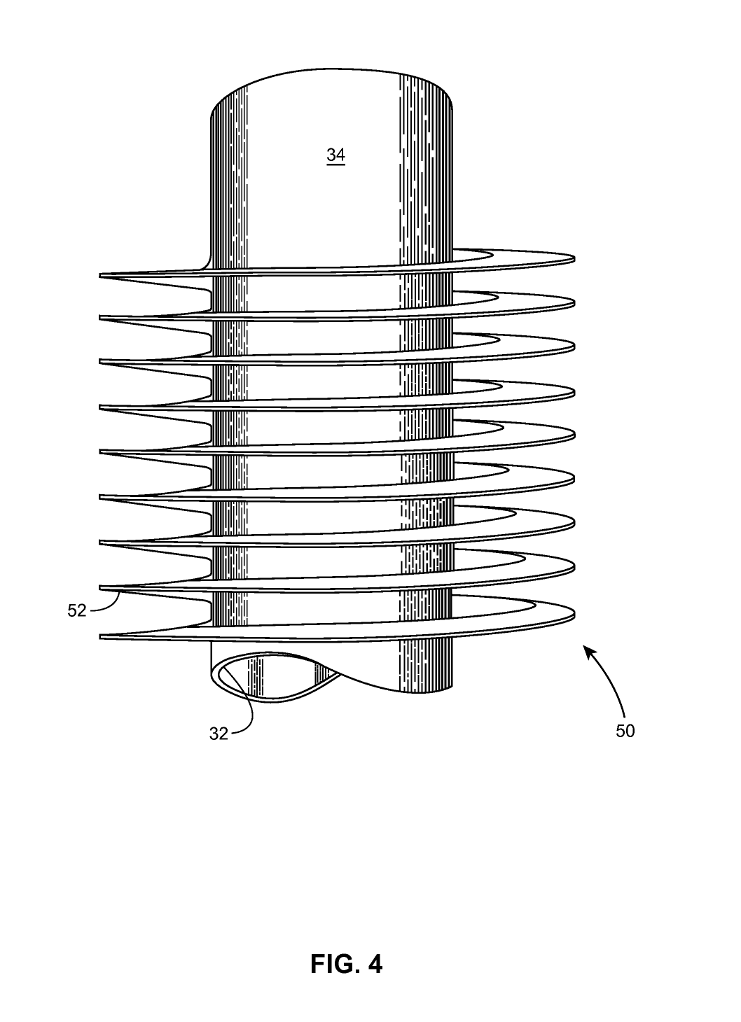

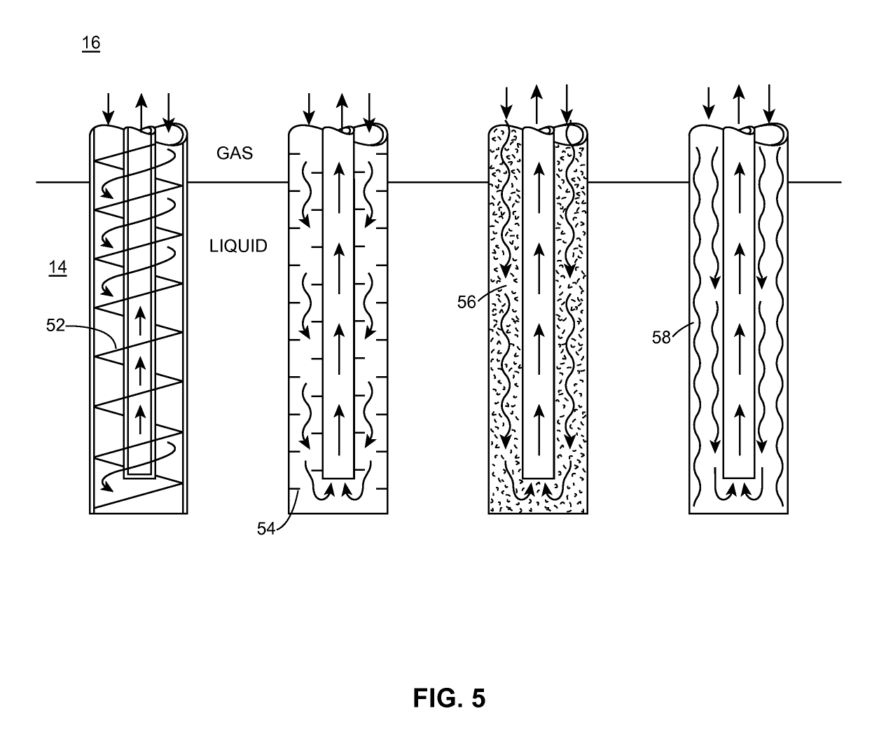

Several examples of flow enhancing features 50 are shown in FIGS. 4-5. Details of a spiral 52 example include a fin spacing of between 3-10 fins per inch of length, a fin thickness of 0.010-0.050 inches, fin height of between 0.25-0.75 inches and a flow enhancing length of 30 cm-60 cm for example. In another example, a plurality of discs 54 extends from the inner 34 and outer 38 tubular members in an alternating pattern. In yet another example, a wool structure 56 fills the annulus 40, and in yet another example, a plurality of convolutions 58 are formed in the outer wall 32, the inner wall 36, or both walls. While these examples are not exhaustive, they illustrate just a few of the flow enhancing features 50 that would work for this application. Other examples are contemplated.

Flow enhancing features 50 could be present inside the inner tubular member 34 alone, in the annulus 40 alone, or in both. In the examples tested, a commercially available, continuous spiral fin feature 52 was affixed about the inner tubular member 34 and extended outward to the outer tubular member 38. The function will next be described in greater detail.

With respect to the present example, the section of transfer line 10 that was inserted into a 250 liter storage dewar 12 comprised a 65 inch long, 0.75 inch outer diameter stainless steel outer tubular member 38 coaxially disposed around a 30 inch long, 0.25 inch outer diameter stainless steel inner tubular member 34. Within this 30 inch length, a 12 inch section of continuous spiral fin 52 was affixed to the inner tubular member 34. This creates a spiral path in the annulus 40 for the gas to flow through, increasing its conduction path length and residence time, before exiting the dewar 12 through the inner tubular member 34 of the transfer line 10.

The upper portion of the outer tube 38 includes a vacuum jacketed space shared with the control valve 22 and the 90″ long flexible vacuum jacketed 20 transfer line. The transfer line 10 was terminated into a vacuum jacketed, 18 inch long, 0.50 inch OD dip tube that was inserted into the device 24 under test. These dimensions can be adjusted for adapting the transfer line 10 to other standard liquid helium dewars (100-liter or 500-liter) that are part of a liquid helium liquefier or separately.

In operation, gas enters the inlet aperture 48 in the outer tubular member 38 at a position within the gas region 16 and exchanges heat with the liquid material (e.g., helium) bath within the liquid region 14 as it flows downward through the circuitous flow enhancing feature 50 in the annulus 40. At the bottom or lower end 42 of the outer tubular member 38, the gas reverses its direction and flows upward through the inner tubular member 34. The inner flow path is separated from the annular flow path by the inner wall 32. The longer effective length of the flow enhancing feature 50 increases significantly the residence time and the transfer of heat from the gas to the liquid bath thereby lowering the outlet temperature of the gas as it exits the dewar 12.

This provides a lower and more consistent gas temperature even as the level of liquid region 14 falls in the dewar 12.

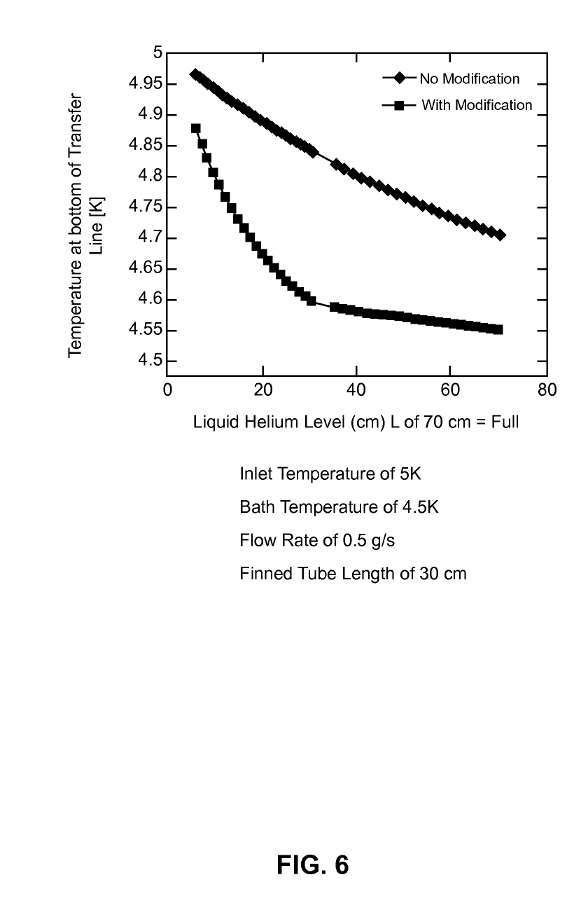

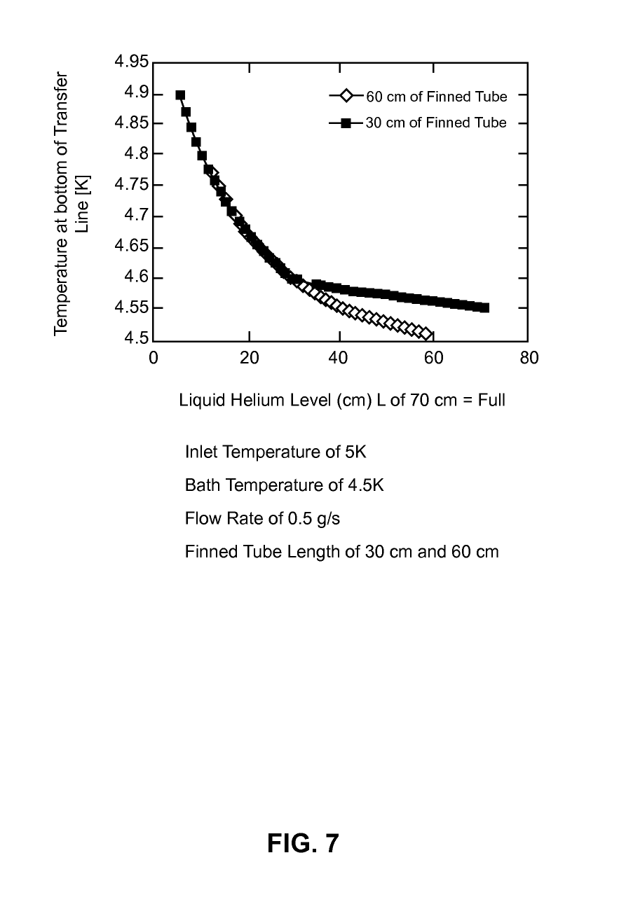

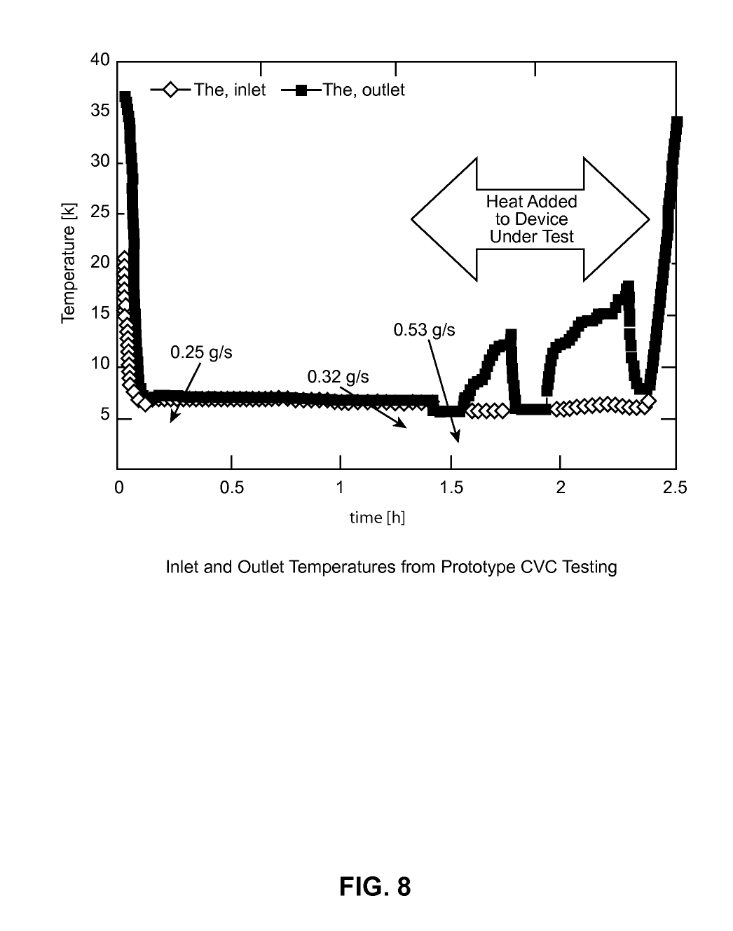

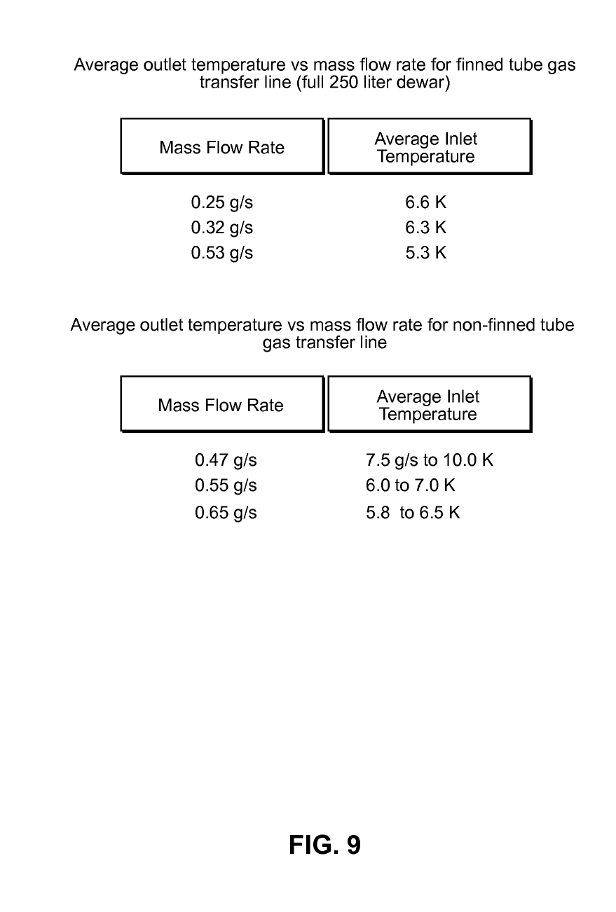

The performance of the transfer line 10 was examined through a series of experiments, with the results shown in FIGS. 6-9, where the outlet temperature of the transfer line 10 was characterized with respect to the measured flow rate & pressure in the dewar 12. The effectiveness of the spiral features 52 was judged through experimental comparison to a co-axial, gas transfer line that was fabricated according to U.S. Pat. No. 5,406,594, which does not include a flow enhancing feature.

While this disclosure describes and enables several examples of a cryogenic material transfer line, other examples and applications are contemplated. Accordingly, the invention is intended to embrace those alternatives, modifications, equivalents, and variations as fall within the broad scope of the appended claims. The technology disclosed and claimed herein may be available for licensing in specific fields of use by the assignee of record.

What is claimed is:

1) An apparatus for transferring a gas stored at a cryogenic temperature from inside a cryogenic storage dewar to a location outside of the storage dewar comprising;
an inner wall defining an inner tubular member disposed coaxially inside of an outer wall defining an outer tubular member with an annulus defined between the coaxial tubular members, said outer tubular member being sealed at a lowest end and defining an inlet aperture at a height that is in a gas region of a storage dewar when the apparatus is inserted into a storage dewar;
a flow enhancing feature disposed inside of the annulus; and
wherein a gas stored at a cryogenic temperature in the gas region of a storage dewar will enter the annulus through the inlet aperture, flow downward through the flow enhancing feature that is disposed within a liquid region located below the gas region of a storage dewar, reverse direction at the lowest end, and flow upward through said inner tubular member and out of a storage dewar when the apparatus is inserted into a storage dewar.

2) The apparatus of claim 1 wherein said flow enhancing feature comprises a spiral finned structure.

3) The apparatus of claim 2 wherein the spiral finned structure is continuous and extends outward from said inner tubular member towards said outer tubular member.

4) The apparatus of claim 3 wherein the spiral finned structure includes a pitch of 3 to 10 fins per inch along the length of said inner tubular member.

5) The apparatus of claim 1 wherein said flow enhancing feature comprises a plurality of discs extending from said inner tubular member and said outer tubular member in an alternating pattern.

6) The apparatus of claim 1 wherein said flow enhancing feature comprises a wool structure.

7) The apparatus of claim 1 wherein said flow enhancing feature comprises convolutions on said outer tubular member.

8) The apparatus of claim 1 and further comprising a cryogenic valve to control a flow of a gas stored at a cryogenic temperature through said inner tubular member.

9) The apparatus of claim 1 and further comprising at least one spacer extending between said inner tubular member and said outer tubular member.

10) The apparatus of claim 1 and further comprising a storage dewar and wherein the apparatus is joined with said storage dewar at a top opening.

11) A method for transferring a gas stored at a cryogenic temperature from inside a storage dewar to a location outside of the storage dewar comprising the steps of:
a) inserting into a storage dewar a transfer line having an inner wall defining an inner tubular member disposed coaxially inside of an outer wall defining a tubular member with an annulus defined between the coaxial tubular members, said outer tubular member being sealed at a lowest end and defining an inlet aperture at a height that is in a gas region of the storage dewar, the transfer line also having a flow enhancing feature disposed in the annulus and within a liquid region that is located below the gas region of the storage dewar;
b) opening a cryogenic valve that controls the flow of a gas within the inner tubular member; and
c) transferring a cryogenic gas from the gas region inside of the storage dewar to the location outside of the storage dewar.

12) The method of claim 11 wherein the transferring step includes directing the cryogenic gas from the gas region into the annulus through the inlet aperture, downward through the flow enhancing feature, to the lowest end and reversing direction, upward through said inner tubular member, and to a location outside of the storage dewar.

13) The method of claim 12 wherein said flow enhancing feature of the inserting step comprises a spiral finned structure.

14) The method of claim 13 wherein the spiral finned structure is continuous and extends outward from said inner tubular member towards said outer tubular member.

15) The method of claim 14 wherein the spiral finned structure includes a pitch of 3 to 10 fins per inch along the length of said inner tubular member.

16) The method of claim 12 wherein said flow enhancing feature of the inserting step comprises a plurality of discs extending from said inner tubular member and said outer tubular member in an alternating pattern.

17) The method of claim 12 wherein said flow enhancing feature of the inserting step comprises a wool structure.

18) The method of claim 12 wherein said flow enhancing feature of the inserting step comprises convolutions on said outer tubular member.
